(19) United States
(12) Patent Application Publication
(10) Pub. No.: US 2004/0117181 A1
(43) Pub. Date: Jun. 17, 2004

(54) Method of speaker normalization for speech recognition using frequency conversion and speech recognition apparatus applying the preceding method

(76) Inventors: Keiko Morii, Kanagawa (JP); Yoshihisa Nakatoh, Kanagawa (JP); Hiroyasu Kuwano, Kanagawa (JP)

Correspondence Address: RATNERPRESTIA, P O BOX 980, VALLEY FORGE, PA, 19482-0980, US

(21) Appl. No.: 10/670,636

(22) Filed: Sep. 24, 2003

(30) Foreign Application Priority Data
Sep. 24, 2002 (JP) 2002-277022

(51) Int. Cl. G10L 15/00

(52) U.S. Cl. 704/234

(57) ABSTRACT

An input speech utterance is segmented into a prefixed time length to make frames, to extract an acoustic feature parameter of each frame. The acoustic feature parameter is frequency-converted by using pluralfrequency conversion coefficients previously defined. By using all combinations of plural post-conversion feature parameters obtained by the frequency conversion and at least one standard phonemic model, to compute plural similarities or distances of between the post-conversion feature parameters of each of the frames and the standard phonemic model. A frequency converting condition for normalizing the input utterance is decided by using the pluralsimilarities or distances. By using the frequency converting condition, the input utterance is normalized. With this method, even in case there is change of the speaker making a speech utterance, the individual difference of input utterance can be corrected thereby improving the performance of speech recognition.

### FIELD OF THE INVENTION

This invention relates to a speaker normalization method for adjusting utterance diversity coming of speaker differences by handling inputted acoustic feature parameters, and to a speech recognition apparatus applying the same method.

### BACKGROUND OF THE INVENTION

A speech recognition apparatus using a speaker normalization method as described in JP-A-2001-255886 is conventionally known. In the speech recognition apparatus, A/D conversion is first made to use to digitize the input speech utterances, thereby extracting feature parameters, such as LPC cepstrum coefficients. Then, boundary of voiced and unvoiced speech is determined to detect voiced and unvoiced speech segment. Then, in order to normalize the effect as caused by the individual difference of the utterances, come from diversity of vocal tract length of the speakers, and the obtained feature parameters, such as LPC cepstrum, is converted on the aspect of frequency axis.

Then, matching is made between feature parameters of input utterance converted on the frequency axis and an acoustic-model feature parameters previously learned with the training utterances by quantities of speakers, to compute at least one recognition result candidate. Thereafter, the optimal conversion coefficient is determined by using the input utterance as a teacher signal, on the basis of a computed recognition result. In order to cancel the variations of speakers or utterances, the frequency conversion coefficients are smoothened and then, updated into new frequency conversion coefficients. The updated, new frequency conversion coefficients are used as new frequency conversion coefficients, to repeat matching with the acoustic-model feature parameter again. In this series of steps, a recognition candidate is finally obtained for use as a recognition result.

Meanwhile, JP-A-2002-189492 describes a speech recognition apparatus using a technique to expand and contract the inputted utterances on their spectral frequency. This art deduces phoneme boundary information on each utterance, to thereby deduce a frequency expansion/contraction condition based on the phonemic segments derived from the phoneme boundary information.

However, these conventional methods have the drawback that a subject-of-recognition word lexicon is needed to carry out speaker normalization. These methods require detail information obtained from detection or deduction about boundary of phonemes, voiced and unvoiced area, and voiced area, inside of each utterance.

### SUMMARY OF THE INVENTION

The present invention is for solving the conventional problem, and it is an object to implement a speaker normalization procedure instead of using a subject-of-recognition word lexicon. Without making a deduction or detection of a segment of information or phoneme thereby correcting for the individual difference of input utterance and improving speech recognition performance.

A method of speaker normalization of the present invention comprises: a feature parameter extracting step of segmentalize one input speech utterance into constant time length frames and compute one or one set of acoustic feature parameters of each frame; a frequency converting step of doing frequency-conversion on the aspect of frequency of one or the one set of acoustic feature parameters by using plural frequency conversion coefficients previously defined; a step of using all combinations of plural converted feature parameter sets obtained by the frequency conversion procedures and one or more standard phonemic models, to compute more than one similarities or distances between the converted feature parameter sets of each of the frames and the standard phonemic model; a step of deciding a frequency converting condition for normalizing the input utterance by using more than one of similarities or distances; and a step of normalizing the input utterance by the previously determined frequency conversion condition.

Meanwhile, an apparatus for speech recognition of the invention comprises: a feature parameter extracting section for segmenting an input speech utterance into a constant time length frames and extracting one or one set of acoustic feature parameters each of the frames; a frequency converting section to convert the acoustic feature parameter on their frequency axis by using more than one of frequency conversion coefficients previously defined; a similarity or distance computing section using all combinations or converted feature parameters obtained by the frequency conversion and the standard phonemic model to compute the similarities or distances between the post-conversion features of the each frames and the standard phonemic model; a frequency conversion condition deciding section for fixing a frequency converting condition to normalize the input utterance on their frequency axis by using the similarities or distances; and a speech-recognition processing section for recognizing an inputted utterance with intended lexicons and intended acoustic models; whereby the input utterance is normalised by using the determined frequency conversion condition, thereby affecting speech recognition.

Thus, normalizing an input utterance in this manner that matching with acoustic feature parameters of standard speaker as previously explained, the difference of input utterances caused by speaker diversity is normalized without using a subject-of-recognition word lexicon, thereby improving the recognition performance.

### BRIEF DESCRIPTION OF THE DRAWINGS

FIG. 1 is a block diagram showing the hardware of a speech recognition system according to embodiment 1 of the present invention;

FIG. 2 is a functional block diagram showing a functional configuration of the speech recognition system according to embodiment 1 of the invention;

FIG. 3 is a flowchart showing a process of the speech recognition system according to embodiment 1 of the invention;

FIG. 4 is a functional block diagram showing a functional configuration of a speech recognition system according to embodiment 2 of the invention;

FIG. 5 is a flowchart showing a process of the speech recognition system according to embodiment 2 of the invention;

FIG. 6 is a functional block diagram showing a functional configuration of a speech recognition system according to embodiment 3 of the invention;

FIG. 7 is a flowchart showing a process of the speech recognition system according to embodiment 3 of the invention;

FIG. 8A is a relationship figure between phoneme and conversion coefficient in each frame according to embodiment 1 of the invention while FIG. 8B is a relationship figure between conversion coefficient and frequency according to embodiment 1 of the invention;

FIG. 9A is a relationship figure between phoneme and conversion coefficient according to embodiment 2 of the invention while FIG. 9B is a relationship figure between selected phoneme and conversion coefficient according to embodiment 2 of the invention;

FIG. 10A is a relationship figure between phoneme and weight in each frame according to embodiment 3 of the invention while FIG. 10B is a relationship figure between conversion coefficient and weight according to embodiment 3 of the invention;

FIG. 11A is a figure showing a result of speech recognition according to embodiment 1 of the invention, FIG. 11B is a figure showing a result of speech recognition according to embodiment 2 of the invention, and FIG. 11C is a figure showing a result of speech recognition according to embodiment 3 of the invention;

FIG. 12 is a block diagram showing the function of an integrated speech remote-control for home-use appliances according to embodiment 4 of the invention; and

FIG. 13 is a figure showing a display screen of a display device according to embodiment 4 of the invention.

### DESCRIPTION OF THE EXEMPLARY EMBODIMENT

Exemplary embodiments of the present invention are demonstrated hereinafter with reference to the accompanying drawings.

### 1. First Exemplary Embodiment

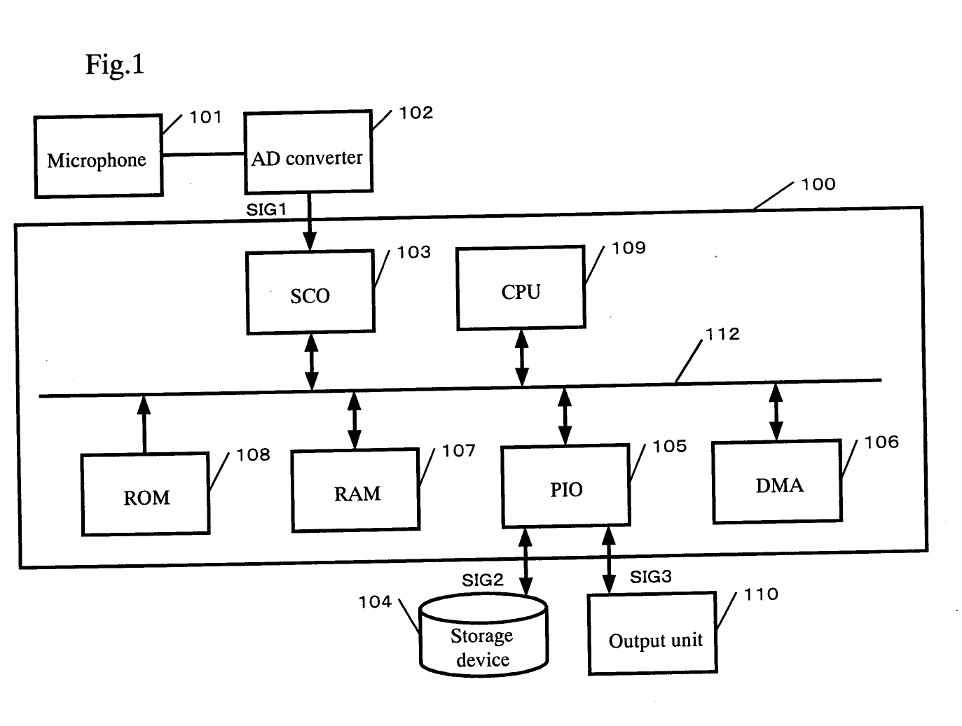

FIG. 1 is a block diagram showing the hardware of speech recognition system using speaker normalization according to the first embodiment of the present invention. In FIG. 1, a microphone 101 captures a speech utterance, and an A/D converter 102 converts the analog signal of utterance into a digital signal. A serial converter (hereinafter referred to as “SCO”) 103 forwards the serial signal from the A/D converter 102 onto a bus data line 112. A storage device 104 is stored with a standard speaker group phonemic model (hereinafter referred to as “standard phonemic model”) as a group of numerals statistically processed of the phoneme-based feature parameters previously learned from the utterances of plural speakers and a word model obtainable by connecting half-syllable-fragment models as a numeral group obtained by statistical processing the half-syllable-fragment based feature parameters previously learned from the plural speakers' utterances.

A parallel IO port (hereinafter referred to as PIO) 105 outputs a standard phonemic model or word model from the storage device 104 onto the bus line 112 synchronously with a bus clock, to output a speech recognition result onto an output unit 110 such as a display. A RAM 107 is a temporary storing memory for use in executing data processing. A DMA controller (hereinafter referred to as “DNA”) 106 controls the high-speed data transfer between the storage device 104, the output unit 110 and the RAM 107.

A ROM 108 is written with a process program and preset data, such as transform coefficients for frequency conversion, referred later. The SCO 103, the PIO 105, the DMA 106, the RAM 107 and the ROM 108 are connected through the bus and placed under control by a CPU 109. The CPU 109 can be replaced with a digital signal processor (DSP).

The elements of SCO 103 to CPU 109 set up a speech recognition apparatus 100.

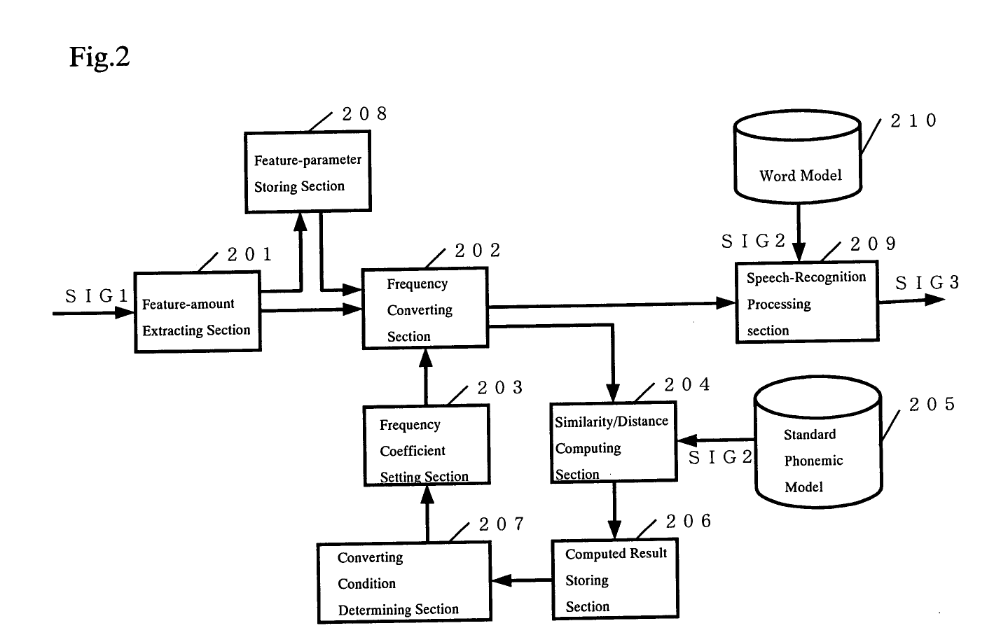

Now, the functional block configuration of the hardware-configured speech recognition apparatus 100 shown in FIG. 1 is explained, with using FIG. 2.

A feature parameter extracting section 201 extracts an acoustic feature parameter or acoustic feature parameters to be obtained by time-divided data of the inputted utterance SIG1. The input utterance, SIG1, is digital data. And their settable sampling frequency has variations as usual speech A/D system, e.g. 6 kHz on telephone speech and 44.1 kHz on CD audio application. The sampling frequency of present embodiment 1 uses 10 kHz.

Meanwhile, the window length and shift width, time division unit for extracting an acoustic feature parameter, can be considered a value of approximately 5 ms to 50 ms. In the present embodiment 1, the window length is assumed 30 ms and the shift width is 15 ms.

An acoustic feature parameter expressing spectrum information is extracted from the time width of divided utterance data. Various parameters are known as feature parameter which expresses spectrum information, such as LPC cepstrum coefficient, LPC mel-cepstrum coefficient, mel-LPC ceptstrum coefficient which is transformed on mel-scale prior to cepstrum-coefficient extraction, MFCC, and delta-cepstrum having a difference between sequential these cepstrum coefficients. In this embodiment, a seven-dimensional LPC mel-cepstrum coefficient vector is extracted.

A frequency converting section 202 carries out a frequency conversion on the feature parameter obtained in the feature parameter extracting section 201. Concerning frequency conversion techniques, a technique of linear expansion and contraction, a technique of shifting, a technique of expansion/contraction or shifting with a non-linear function, and others are known. The present embodiment 1 carried out a non-linear expansion and contraction using a linear all-pass filter function expressed by Equation 1.

$${\overline{z}}^{- 1} = \frac{{z}^{- 1} - α}{1 - α {z}^{- 1}} \qquad Equation 1$$

α in Equation 1 is referred to as a frequency conversion coefficient (hereinafter referred to as “conversion coefficient”). Although the conversion coefficient α is in nature a variable value, the present embodiment 1 used seven discrete values α₁ to α_{z}, i.e. ‘−0.15’, ‘−0.1’, ‘−0.05’, ‘0’, ‘+0.05’, ‘+0.10’ and ‘+0.15’, for the convenience of processing. These are hereinafter referred to as a conversion coefficient group.

A frequency converting section 202 makes a frequency conversion process using installed conversion coefficient according to Equation 1. A conversion-coefficient setting section 203 sets the frequency converting section 202 with plural conversion coefficients. A similarity, which means similarity degree, or distance computing section 204 reads standard phonemic model data from a standard phonemic model 205, and computes a similarity or distance thereof to each of plural input acoustic feature parameters after conversion (hereinafter referred to as “post-conversion feature parameter”) on plural conversion coefficients obtained from the frequency converting section 202. The similarity or distance in this embodiment is detailed later. Meanwhile, the computation result is stored in a result storage section 206.

The standard phonemic model 205 comprises a group of numerals as a result of the statistically processed feature parameter on the following 24 phonemes:

/a/,/o/,/u/,/i/,/e/,/j/,/w/,/m/,/n/,/ng/,/b/,/d,/,
/r/,/z,/hv/,/hu/,/s/,/c/,/p,/t/,/k/,/yv/,/yu/,/n/.

Selecting the phoneme is described in The IEICE (in Japan) Transactions on information and Systems, Pt, 2 (Japanese Edition) D-11 No. 12 pp. 2096-pp. 2103.

A word model 210 is to represent a subject-of-recognition word obtained by connecting half-syllable-fragment models, and corresponds to one example of subject-of-recognition standard acoustic model. The standard phonemic model 205 and the word model 210 are both stored in the storage device 104. The both trained with the same utterance set of the same standard speaker group by the use of a statistical process.

A conversion-condition determining section 207 determines a conversion condition for use in speech recognition from the result of storage in the result storing section 206.

A feature-parameter storing section 208 is a memory for temporarily storing the feature parameter extracted in the feature-parameter extracting section 201 until speech recognition process is completed. Part of the RAM 107 is allocated to store them.

A speech-recognition processing section 209 operates a similarity or distance between a frequency-converted feature parameter and a word model 210, to thereby determine a word. Meanwhlle, the recognition result is outputted to an output unit 110.

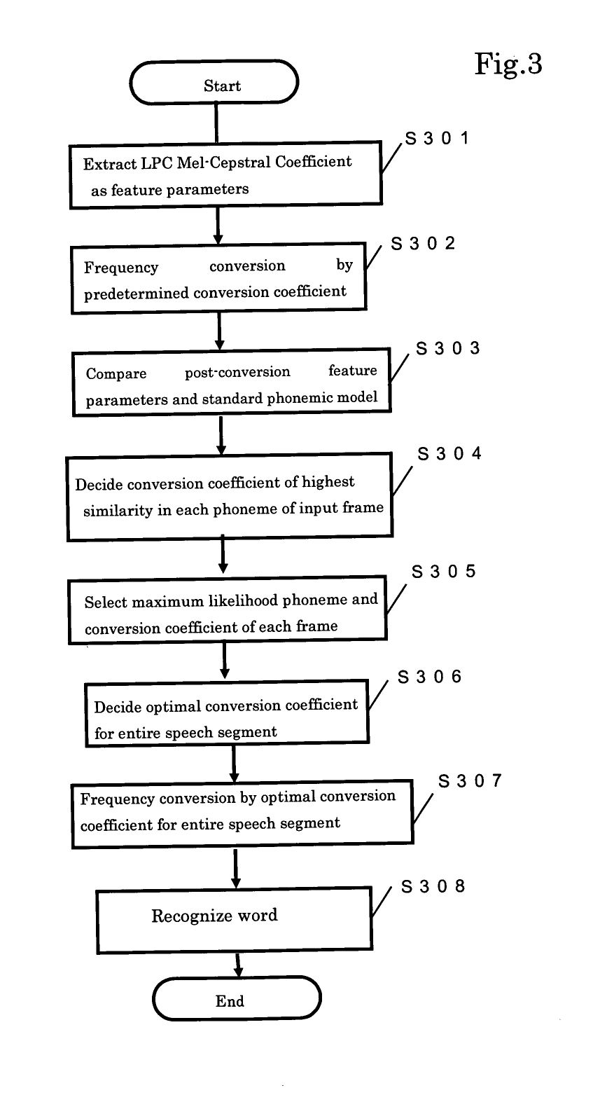

The operation of the speech recognition apparatus 100 thus functionally configured is explained by using the flowchart shown in FIG. 3.

At first, the feature-parameter extracting section 201 extracts a seven-dimensional LPC mel-cepstrum coefficient vector as an acoustic feature parameter, frame by frame, from the utterance inputted through a microphone 101 and then changed to a digital signal through the A/D converter 102 (step S301). The extracted feature parameter is outputted to the frequency converting section 202 and simultaneously stored to the feature-parameter storing section 208.

Then, the conversion coefficient setting section 203 sets the frequency converting section 202 with a predetermined conversion coefficient. The frequency converting section 202 makes a frequency conversion on the acoustic feature parameter by this conversion coefficient, according to Equation 1, thereby determining a post-conversion feature parameter. The conversion is made on all the conversion coefficients of the conversion coefficient group. Hence the number of converted feature parameters of each frame is same to the number of conversion coefficients included in the conversion coefficient group (step S302).

The similarity or distance computing section 204 compares one set of the converted feature parameter with all phonemes of standard phonemic model read out of the standard phonemic model 205. This comparison can use both methods, a method of compare between single frames and a method of compare between plural frames, by adding the preceding/succeeding several frames. In the embodiment 1, a similarity or distance computation use a width of 7 frames added with the respective preceding and succeeding 3 frames to a focusing frame. And compare to calculate the similarity or distance of inputted data and standard phonemic model included in the standard phonemic model 205 (step S303).

The result is stored to the result storing section 206. Incidentally, the similarity or distance computing section 204 makes a computation process of similarity or distance on all the computed post-conversion feature parameters.

As the method of computing a similarity or distance between a converted feature parameter and a standard phonemic model, there are a method of using a similarity making by a phonemic recognition with statistic processed model having distribution as a standard speaker group of utterance model, and a method of using a physical distance with a phoneme-based representative value as a standard speaker group of utterance model. However, the similar effect is available even upon using another similarity degree or distance measure.

Now, two examples are explained on the standard phonemic model 205 in which the phonemes for use in speaker normalization are modeled.

The first sample is a case to use a similarity sought by making phoneme recognition with adopting a statistic process having a distribution as a standard speaker group of utterance model. In this case, Mahalanobis generalized distance is used as a measure to determine a similarity for phoneme recognition, wherein measurement take place by collected acoustic feature parameter of successive 7 frames in an utterance part corresponding to each phoneme of standard speaker utterances, and a mean value and covariant matrix is sought to make a conversion into coefficient vectors.

The second example is a case to use a physical distance by adopting a phoneme based selected value as a standard speaker group of utterance model. This is configured by a mean vector group of acoustic feature parameter in successive 7 frames of an utterance part corresponding to each phonemes from a standard speaker or utterance.

Incidentally, Mahalanobis generalized distance is explained in JP-A-60-67996, for example.

The results of the two cases, i.e. the case of using the phonemic recognition similarity and the case of using the distance to the phoneme-based typical value, are described later.

The data stored in the result storing section 206 must be a distance to a phoneme-based selected value, a representative model, or a likelihood of phonemic recognition with each input frame and 24 phonemes phone-based selected value.

The steps S301 to S303 are executed on all the frames in the speech segment.

Then, the conversion-condition determining section 207 determines a conversion coefficient candidate of the highest similarity to the phoneme within the input frame according to Equation 2 (step S304).

$$\hat{α} = arg {max}_{α} L ( {X}^{α} \vert α , θ ) \qquad Equation 2$$

In Equation 2, L expresses the similarity, X^{α} the spectrum given by frequency conversion along Equation 1, α the conversion coefficient and θ the standard phonemic model. A conversion coefficient α is searched and decided which makes the similarity degree maximize between a spectrum X^{α} and a standard phonemic model θ. This embodiment 1, using seven discrete values α₁ to α₇ for the convenience of processing, selects and decides a conversion coefficient α at which the highest similarity is obtainable from among the similarities in the respective cases to which all the seven discrete values are applied. Namely, the similarities obtained from applying the seven discrete values are mutually compared, to select a conversion coefficient α at which the highest similarity is obtainable.

In the case that comparing the phonemic feature parameter results in distance, a conversion coefficient representative of the nearest distance is decided according to Equation 3.

$$\ddot{a} = arg {max}_{α} D ( {X}^{α} \vert α , θ ) \qquad Equation 3$$

In Equation 3, D represents the distance, X^{α} the spectrum given by frequency conversion along Equation 1, α the conversion coefficient and θ the standard phonemic model. A conversion coefficient α is searched and decided which makes minimum the distance between a spectrum X^{α} and a standard phonemic model θ. This embodiment selects and decides a conversion coefficient α at which the smallest or nearest distance is obtainable, from among the distances in the respective cases to which all the seven discrete values are applied. Namely, the distances obtained from applying the seven discrete values are mutually compared, to select a conversion coefficient α at which the smallest distance is obtained.

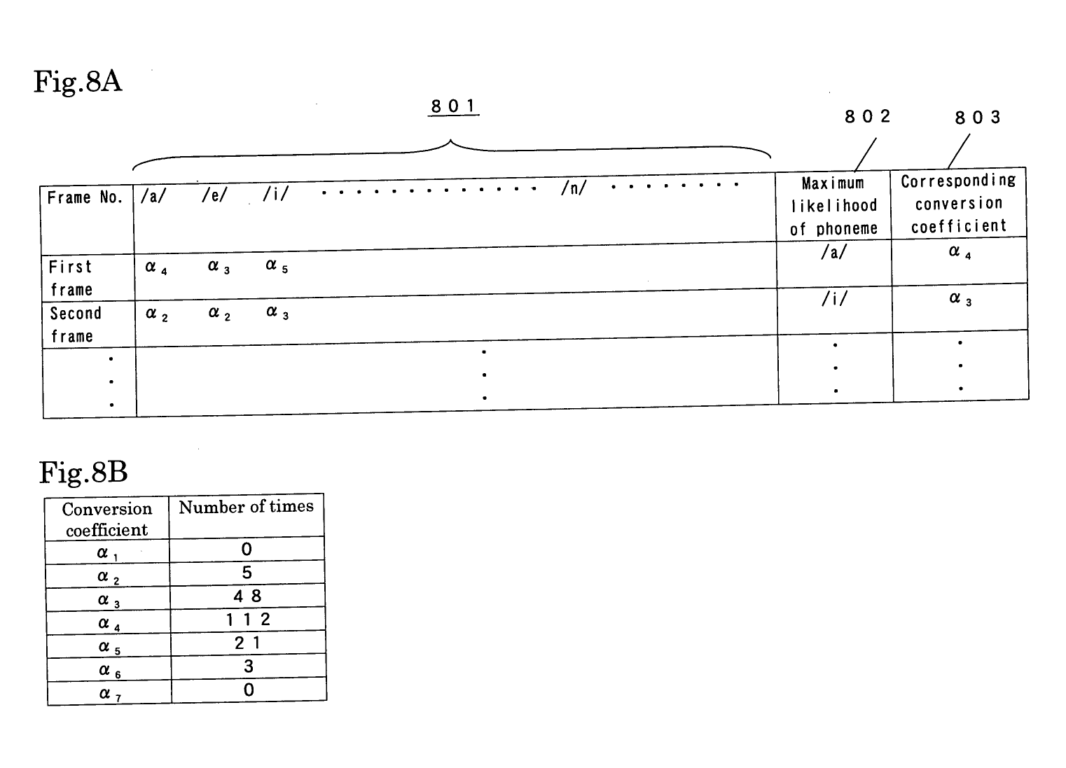

Then, a phenome highest in similarity degree or smallest in distance to the input is selected frame by frame, to determine a conversion coefficient in a manner nearing the phoneme of standard phonemic model (step S305). FIG. 8A is a figure showing the phoneme-based conversion coefficients on all the frames showing this status. In FIG. 8A, the maximum likelihood of conversion coefficient 801 is selected for each phoneme within the frame, to determine the maximum likelihood of phoneme 802 by computing a similarity or distance. Then, a conversion coefficient 803 corresponding to the relevant phoneme is determined. For example, in the case that step S305 determines that the maximum likelihood in the first frame is selected under the condition of a phoneme /a/ and conversion coefficient α₄, the conversion coefficient α₄ used in that frequency conversion is given as a conversion coefficient for the first frame.

Then, the conversion-condition determining section 207 cumulatively stores the occurrence frequency over the entire speech segment under the frequency converting condition corresponding to the selected phoneme, for each frame determined in the step S305. Then, the stored occurrence frequencies are compared each other to determine the conversion coefficient of highest occurrence frequency as a frequency converting condition for the entire segment, and notifies it to the conversion-coefficient setting section 203 (step S306). FIG. 8B is a figure showing the relationship between the conversion coefficients and the cumulating frequency. In FIG. 8B, α₄ is given a frequency converting condition because of α₄ having the greatest frequency.

By the above steps S301 to S306, a frequency conversion coefficient for us in a speech recognition process is determined. According to the steps S301 to S306, one conversion coefficient is selected for frequency conversion for each input frame. However, because there are differences between the conversion-coefficients selected based on each input frame, speaker normalization can be implemented more finely based on each input frame. Thus, any utterance input can be normalized about speaker-based difference.

Then, the conversion-coefficient setting section 203 sets a notified conversion coefficient to the frequency conversion section 202. After this transaction, the frequency converting section 202 reads a stored feature parameter out of the feature-parameter storing section 200, and carries out a frequency conversion over the entire speech segments starting from the first frame (step S307). The converted feature parameter as a result of that procedure is outputted to the speech-recognition processing section 209.

These steps S301 to S307 are for the processing of speaker normalization. Because this process normalizes the input utterance in a manner matched to the standard speaker, the input utterance is normalized for its speaker-based difference thereby improving recognition performance.

Then, the speech-recognition processing section 209 carries out a speech recognition process using the converted feature parameter. For this processing method, a method using Hidden Markov model, a method with dynamic time warping, a method with neural networks, and et al. are known. The present embodiment 1 used a speech recognition method disclosed in JP-A-4-369696, JP-A-5-150797 and JP-A-6-266393. The speech-recognition processing section 209 carries out a speech recognition process by the use of an input and word model, and outputs a recognized word as a speech recognition result to the output unit 110 (step S308).

As described above, the present embodiment 1 determines a frequency converting condition using with the similarities or distances of all the 24 phonemes, being considered to be sufficient in speech recognition. Using this speech normalization is able to improve the recognition performance for every speech utterance, which can be inputted to the speech recognition apparatus.

The stop S307 of this embodiment 1 cumulatively stored the number of occurrences of frequency converting conditions for all selected phonemes, but it is possible to count and store the number of times when the selected phoneme is only a vowel. This procedure determines a frequency converting condition for the entire segment from the information of only vowels, that has highest reliability to a subject of frequency conversion. Hence it is possible to provide the higher reliability than a determined frequency converting condition.

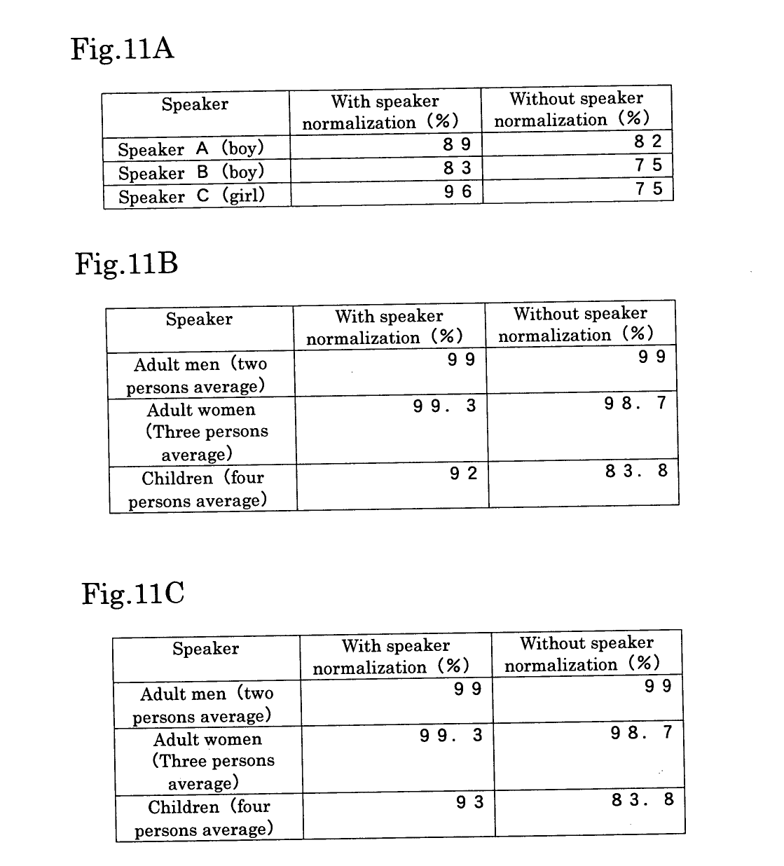

FIG. 11A shows results of speech recognitions with speaker normalization carrying out and without carrying out, according to the present embodiment 1 in the respective cases. This test was conducted with 100-word utterance by three spekers who are not included in the acoustic model trained speakers, with using a word lexicon having an entry of 100 words. Speaker normalization improved the recognition rate by 7 to 21%. This can confirm that the above effect is obtainable, even in case speaker normalization is conducted in continuing-length-fixed phoneme recognition, without using a subject-of-recognition word lexicon, and without segment detection of voiced and unvoiced sound, in computing a distance between input and standard phonemic model.

Incidentally, the present embodiment 1 determines a conversion coefficient adapted over the entire speech segment after making a frequency conversion process over the entire speech segment. However, it is possible to take it as a conversion coefficient adaptable over the entire speech segment at a time point that any of conversion coefficients has been selected as a frequency converting condition a predetermined number of times. This can reduce the time of speech recognition.

### 2. Second Exemplary Embodiment

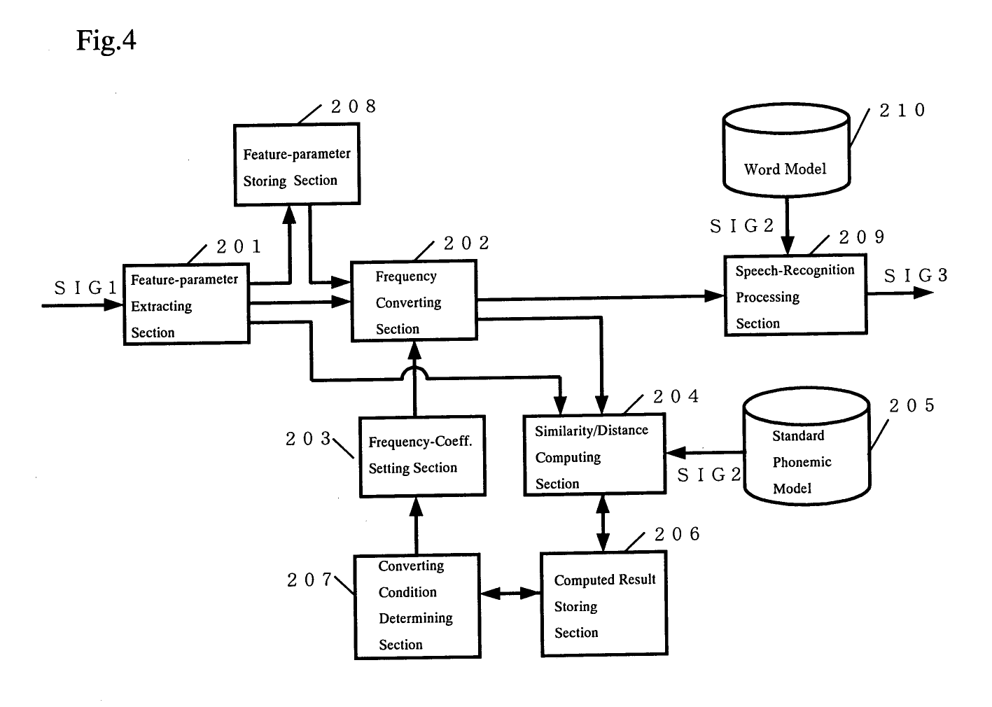

FIG. 4 shows a functional configuration of a speech recognition apparatus according to a second embodiment of the invention. This is different from the first embodiment in that a similarity or distance computing section 204 compares, with a standard phonemic model 205, an acoustic feature parameter outputted from a feature-parameter extracting section 201 besides an output from a frequency converting section 202. There is a further difference in that a conversion-condition determining section 207 determines a conversion condition by using a result of representation phoneme, referred later, of among the results obtained from the similarity or distance computing section 204 and stored in a result storing section 206.

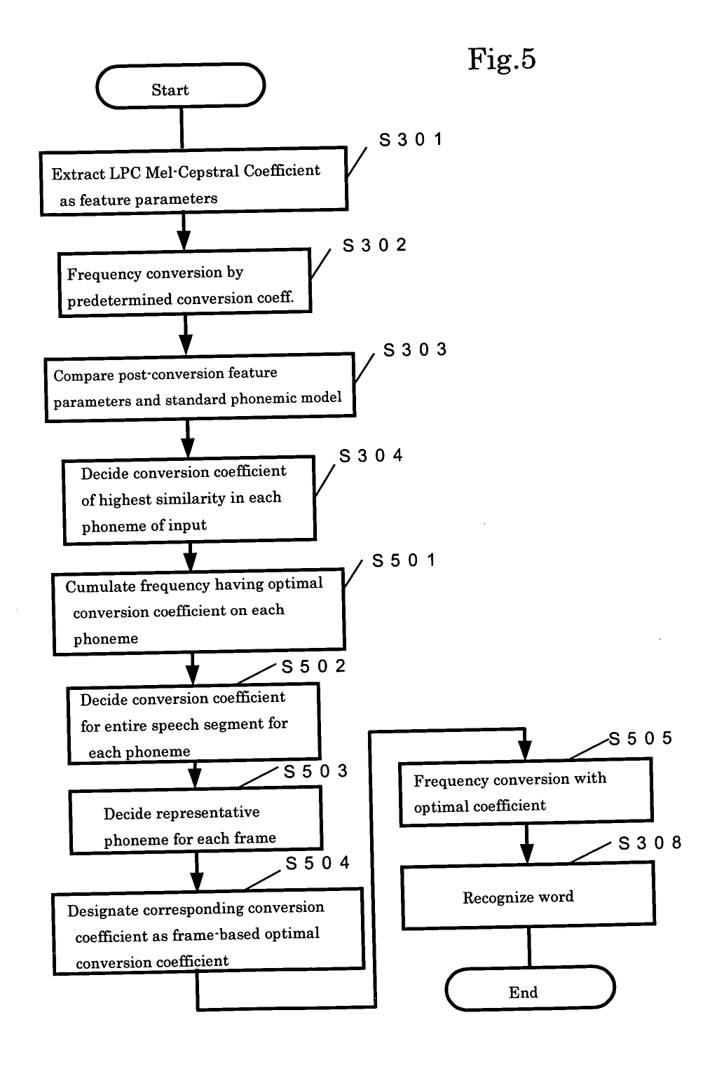

Now, the speech recognition operation of the present embodiment 2 is explained with using FIGS. 4 and 5. The former half process of steps S301 to S304 in FIG. 5 is similar to that of the steps of the embodiment 1 explained in FIG. 3, wherein the conversion-condition determining section 207 determines a phoneme-based frequency converting condition for each frame.

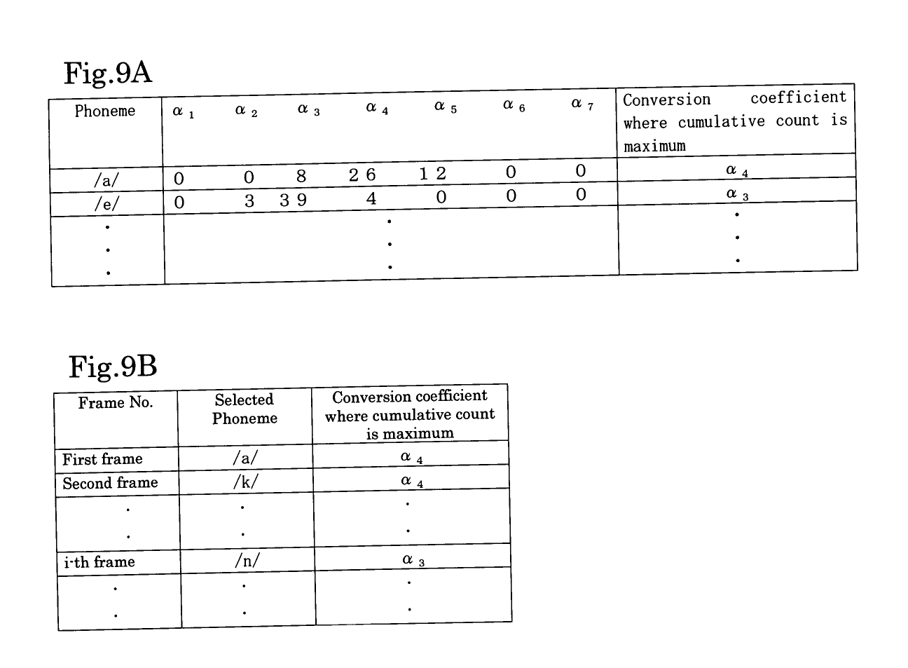

Then, the conversion-condition determining section 207 cumulatively stores the occurrence frequency of frequency-conversion conditions decided on each phoneme in the step S304 (step S501). FIG. 9A is one example of figure showing the relationship between a phoneme and a conversion coefficient generated as a result of this process. Meanwhile, the conversion-condition determining section 207 selects a conversion coefficient in highest-frequency, for each phoneme, and decides it as a conversion coefficient of the phoneme for the entire speech segment (step S502). FIG. 9A shows that α₄ is selected as a conversion coefficient for the phoneme /a/ while α₂ is selected as a conversion coefficient for the phoneme /e/.

At the same time, the conversion-condition determining section 207 decides a phoneme representative for each frame of the relevant input frame, over the entire segment of input frame (step S503). In this embodiment, the similarity or distance computing section 204 compares an output of the feature parameter extracting section 201 with each standard phonemic model stored in the standard phonemic model 205, to select as a typical phoneme, with the highest similarity of among the similarities stored in the result storing section 206 or with minimum distance to the phoneme-based representative value.

Meanwhile, the conversion-condition determining section 207 selects a conversion coefficient corresponding to a representative phoneme of the input frame, depending upon the decision in the step S502. This process is made over the entire segment of input frame, making notification to the conversion-coefficient setting section 203 (step S504). FIG. 9B is one example of figure showing a relationship between a representative phoneme of every frame and the corresponding conversion coefficient.

Then, the conversion-coefficient setting section 203 sets the frequency converting section 202 with an adaptive, notified conversion coefficient, for each input frame. The frequency converting section 202 in turn reads a stored feature parameter out of the feature-parameter storing section 208, and carries out a frequency conversion process for delivering to the speech-recognition processing section 209 (step S505). This process is carried out over the entire speech segment.

The above steps S301 to S505 are for the processing of speaker normalization in the present embodiment 2. The subsequent speech-recognition processing step S308 is identical to the speech-recognition processing step S308 explained on FIG. 3 in the embodiment 1.

As described above, the present embodiment 2 selects one conversion coefficient for carrying out a frequency conversion on each input frame. However, because the conversion coefficient is selected on each input frame one by one, speaker normalization can be affected finely frame by frame. Speech utterance, in any, can be inputted to the speech recognition apparatus using the speech normalization, thus improving the performance of recognition.

FIG. 11B shows a result of speech recognitions according to the present embodiment 2 in the respective cases in which speaker normalization is carried out and not carried out. This test was conducted with 100 word input utterance by nine speakers who are not included in the acoustic model trained speakers, with using a word lexicon having an entry of 100 words. Speaker normalization improved the recognition rate by 8.2% of the children who had been lower than that of adults. This can confirm that the above effect is obtainable even in case a speaker normalization condition is determined by using a result of a continuing-length fixed phoneme recognition or of a distance computation between an input and a phoneme standard phonemic model, without segment detection of voiced and unvoiced sound, and without carrying out a recognition process using a subject-of-recognition word lexicon.

### 3. Third Exemplary Embodiment

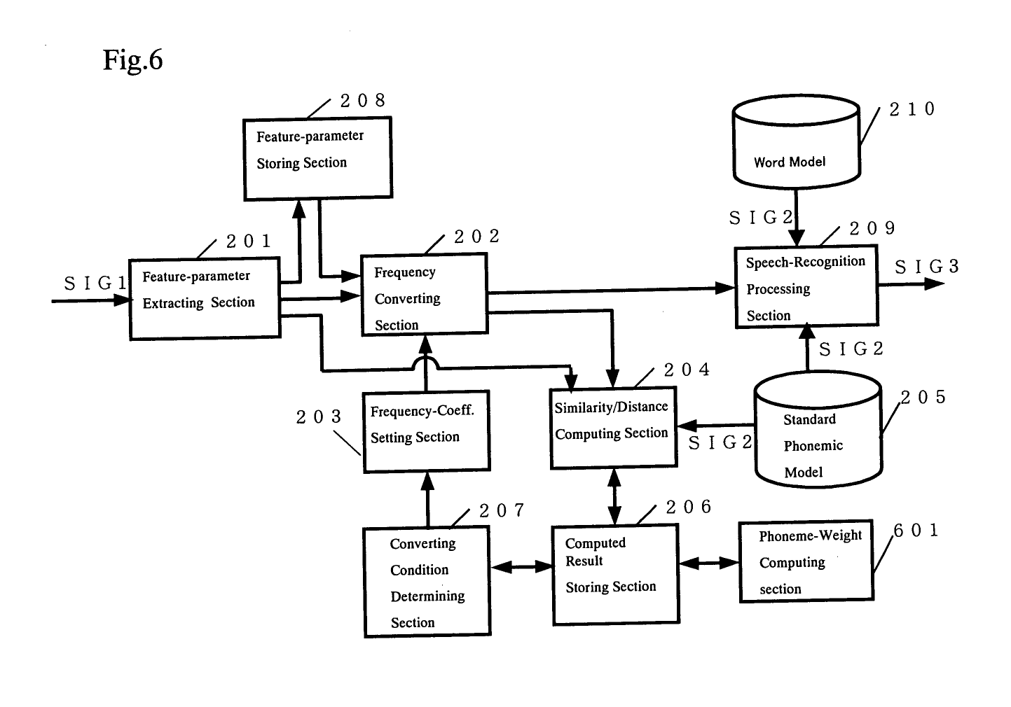

FIG. 6 shows a functional configuration of a speech recognition apparatus according to a third embodiment of the invention. This is different from the second embodiment in that there is provided a phoneme-weighting computing section 601 for computing a weight of each phoneme from a feature parameter.

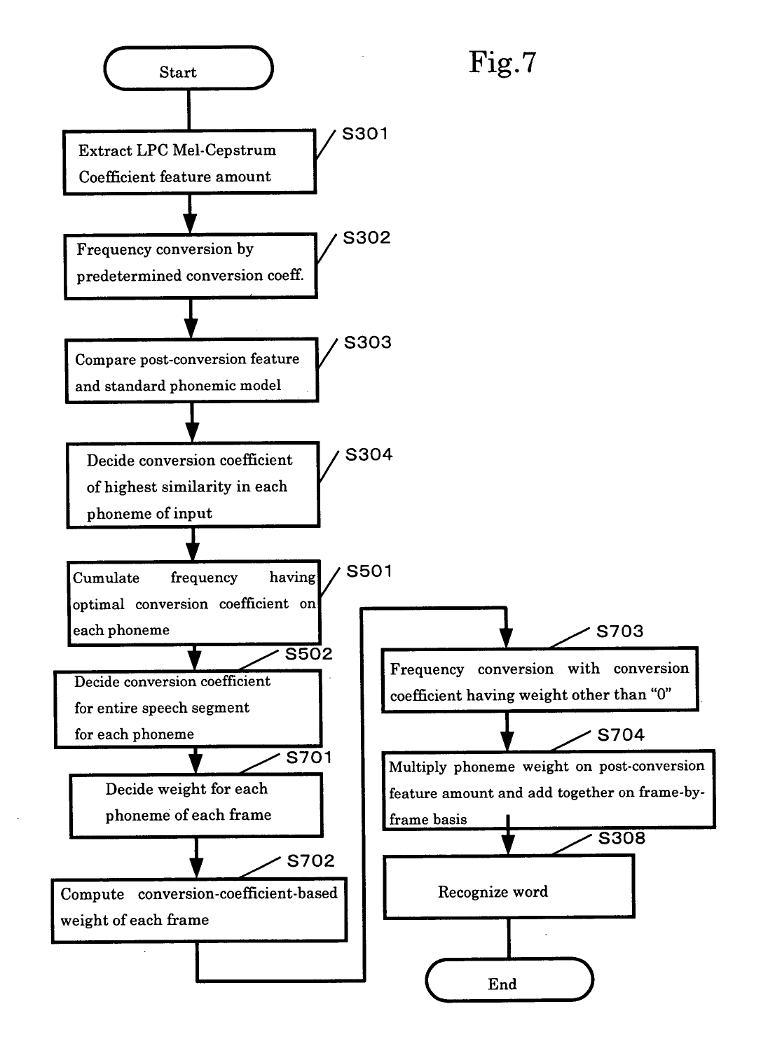

Now, the operation of speech recognition of embodiment 3 is explained with using FIGS. 6 and 7. The former-half process of steps S301 to S502 is similar to that of FIG. 5 explained in the second embodiment, i.e. the conversion-condition determining section 207 determines a frequency converting condition for each phoneme.

A conversion-condition determining section 207 determines phoneme weights, frame by frame, for the entire segment of input speech (step S701). For determining the weights, a similarity r distance computing section 204 computes a similarity degree between an output of the feature-parameter extracting section 201 and each phoneme standard phonemic model of standard phonemic model 205 or a distance thereof to a phoneme-based representative value. The computed distance is stored in a result storing section 206. Thereafter, a conversion-condition determining section 207 determines a normalized weight by using Equation 4.

In Equation 4, wᵢₖ represents the weight, X the input spectrum, V the phoneme-based representative value vector, k the phoneme kind, p the parameter representative of a smoothness of interpolation, and d(X, V) the distance of between an input spectrum and a phoneme-based representative value as determined according to Equation 5.

$${W}_{ik} = \frac{{d ( {X}_{i} , {V}_{k} )}^{- p}}{{\sum }_{k} {d ( {X}_{i} , {V}_{k} )}^{- p}} \qquad Equation 4$$

d(X, V)=∥i X−V∥² Equation 5

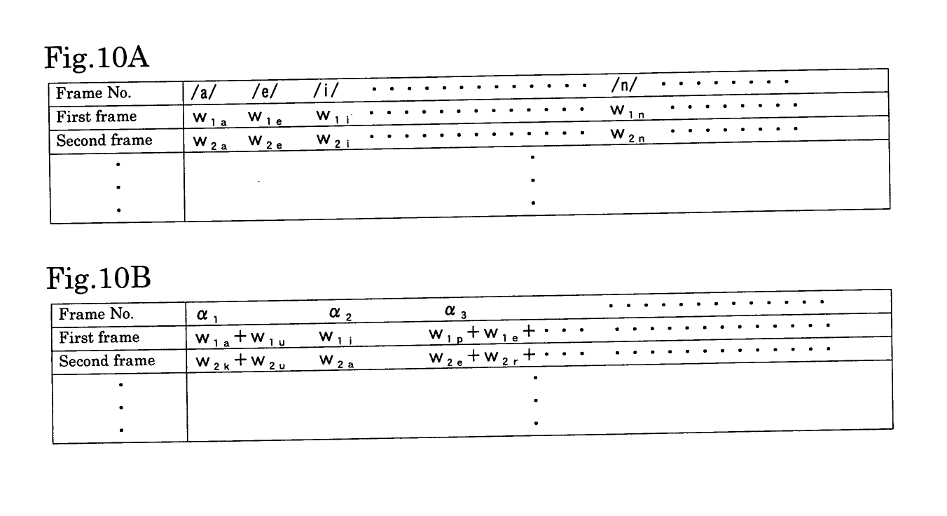

The conversion-condition determining section 207 carries out the above process over the entire speech segment, to compute a phoneme-based weight on each frame. As a result of the computation, obtained is a relationship between a phoneme of each frame and a phoneme-based weight, as shown in FIG. 10A. This result is recorded in a result st ring section 206.

Then, a phoneme-weight computing section 601 computes a conversion-coefficient-based weight of each frame, from the relationship between each phoneme and the corresponding frequency converting condition over the entire speech segment determined in the step S502 (see FIG. 8A) and the relationship between a phoneme of each frame and a phoneme-based weight determined in the step S701 (see FIG. 10A) (step S702). FIG. 10B shows this relationship. Then, the phoneme-weight computing section 601 stores the computation result in the result storing section 206.

Then, the conversion-condition determining section 207 reads the conversion-coefficient-based weight of each frame out of the result storing section 206, and notifies, frame by frame, the conversion-coefficient setting section 203 of the conversion coefficient having a weight other than “0”. The conversion-coefficient setting section 203 sets the frequency converting section 202 with the notified conversion coefficient. The frequency converting section 202 again carries out a frequency conversion starting at the first frame by the use of the conversion coefficients, and outputs a post-conversion feature parameter to the similarity or distance computing section 204 (step S703).

Then, the speech-recognition processing section 209 reads a relationship between a conversion coefficient and a weight of each frame from the result storing section 206, and multiplies a weight corresponding to the conversion coefficient on the conversion coefficient obtained in the step S704. This process is made sequentially on all the conversion coefficients notified from the conversion-condition determining section 207, followed by summing up those (step S704). This computation can be carried out according to Equation 6.

$${\tilde{X}}_{1} = {\sum }_{k} ( {W}_{ik} - {\hat{X}}_{i} ( {\overline{α}}_{k} ) ) \qquad Equation 6$$

In Equation 6, \hat{X}_{⊥} is the feature parameter of an input utterance, \overline{X}₁ is the post-conversion feature parameter, \overline{α}ₖ is the conversion coefficient and wᵢₖ is the weight.

The above steps S301 to S704 are for the processing of speaker normalization. The subsequent speech recognition process step S308 is similar to the speech recognition process step S308 of FIG. 3 explained in the embodiment 1.

The above process of the steps S703 to S308 is carried out over the entire speech segment.

As described above, in the present embodiment 3, the conversion coefficient for frequency-converting the spectrum of each input frame is selected in plurality to make a weighted summing-up process, wherein the weight set value is different between input frames. Consequently, speaker normalization can be accurately implemented frame by frame. Speech utterance, in any, can be inputted to the speech recognition apparatus using the speech normalization, thus improving the performance of recognition.

Meanwhile, because weight is determined by using feature parameters before frequency conversion, it is possible to avoid frequency conversion from doubly affecting during frequency conversion. Thus, the effect can be suppressed low for the speaker utterance the frequency conversion of which tends to act toward the worse.

FIG. 11C shows a result of speech recognitions according to the present embodiment 3 in the respective cases in which speaker normalization is carried out and it is not carried out. This test was conducted with 100-word input by nine speakers who are not included in the acoustic model trained speakers, with using a word lexicon having an entry of 100 words. Speaker normalization improved by 9.2% the recognition rate of the children who had been lower than that of the adult.

This can confirm that the above effect is obtainable even in case a speaker normalization condition is determined by using a result of continuation-length-fixed phoneme recognition in the absence or segment detection of voiced and unvoiced sound or of distance computation between an input and a standard phonemic model, without carrying out a recognition process using a subject-of-recognition word lexicon.

Meanwhile, the present embodiment, although explained the effect or speaker normalization in case of recognizing words, is similarly applicable to recognizing sentences or conversation speech.

### 4. Fourth Exemplary Embodiment

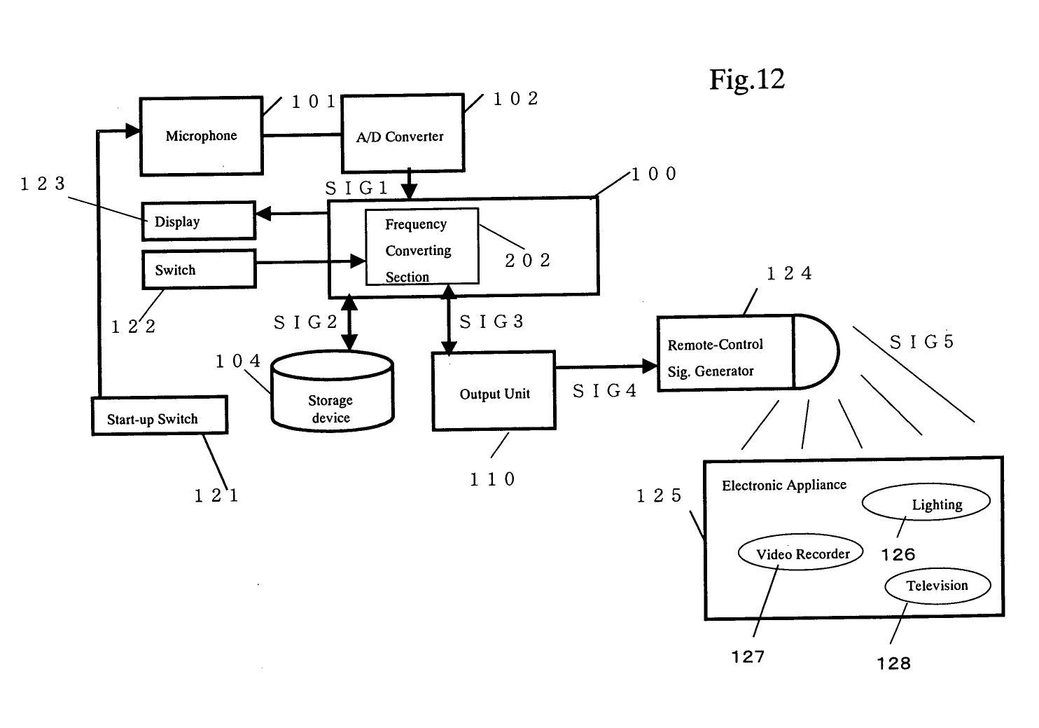

FIG. 12 shows a block diagram showing the function of an integrated speech remote-control unit for home-use appliances according to a fourth embodiment of the invention.

A start-up switch 121 instructs a microphone 101 to start capturing a speech utterance, in order for the user to start up the integrated speech remote-control unit for home-use appliances. A switch 122 is for the user to input to a speech recognition apparatus 100 an instruction of whether speaker normalization is to be made or not. A display unit 123 displays whether speaker normalization is in process or not from the speech recognition apparatus to the user. A remote-control signal generator unit 124 receives a speech recognition result (SIG4) from an output unit 110 and outputs an infrared ray of remote-control signal (SIG5). An electronic appliance group 125 receives an infrared-ray remote-control signal (SIG5) from the remote-control signal generator unit 124.

Incidentally, it is possible to make a configuration not including the start-up switch 121. In such a case, the configuration may be such that the microphone 101 captures a speech utterance at all times and sends speech data to an A/D converter 102 at all times, or the microphone 101 observes the change of power so that, when an increment in a constant time exceeds a threshold, handling is effected similarly to the case there is an instruction from the start-up switch 121. The operation of the microphone 101, A/D converter 102, storage device 104 and output unit 110 is similar to the operation of FIG. 1, and the explanation is omitted herein.

In the below is explained a case that a speech recognition apparatus 100 of the present embodiment 4 uses the speech recognition apparatus explained in the embodiment 3. Note that it is possible to use any of the speech recognition apparatuses explained in the embodiments 1 to 3.

In the integrated speech remote-control unit for home-use appliances of the present embodiment 4, the user is allowed to select whether or not to carry out speaker normalization depending upon an input to the switch 122. The switch 122 has one button, to switch over whether or not to carry out speaker normalization each time it is depressed. The instruction due to depressing the switch 122 is notified to the speech recognition apparatus 100. When speaker normalization is not carried out, the fact is notified to a frequency converter section 202 provided in the speech recognition apparatus 100, to change the process to output a feature parameter without making a frequency conversion process. The situation of whether speaker normalization is being carried out or not is displayed on the display unit 123. Accordingly, the user can always grasp the situation in a simple way. The start-up switch 121 also has one button. During a constant time after the user depresses the start-up switch 121 in order to start a speech recognition, the microphone 101 captures a speech utterance at all times and continuously delivers it to the A/D converter 102. The A/D converter 102 is also continuously delivering digitized utterance data to the speech recognition apparatus 100.

After the user depresses the start-up switch 121, in the case the power of an input utterance continuously exceeds a preset threshold for 1 second or longer and then becomes smaller than the threshold, the utterance by the near is considered ended and the microphone 101 halts the capture of utterance. The time value of 1 second exceeding the threshold is a mere one example. This can be changed by setting the microphone 101, depending upon a length of words to be recognized. Conversely, in the case 3 seconds elapse even if there is less variation in the utterance power, user's speech input is considered halted to cease speech capture. The time up to halting speech capture may be 5 seconds or 2 seconds, i.e. it may be changed by setting the microphone 101 depending upon the situation the apparatus is used. In case the microphone 101 halts the speech capture process, the process of the A/D converter 102 and subsequent is ceased. The speech utterance data thus captured is rendered a subject of speech recognition process in the speech recognition apparatus 100, and a result obtained is outputted to the output unit 110.

For example, in the case that the user desires to put a lighting by the integrated speech remote-control unit for home-use appliances in a state the switch 122 is pushed in, in case giving an utterance “lighting” in a state the start-up switch 121 is depressed, an utterance is captured through the microphone 101 and converted into a digital signal in the A/D converter 102, then being sent to the speech recognition apparatus 100. The speech recognition apparatus 100 carries out a speech recognition process.

In the example of this embodiment 4, the storage device 104 is previously stored with such words as “video recorder”, “lighting”, “electricity” and “television” as subject-of-recognition words correspondingly to the electronic appliance group 125 as a subject of operation. In case the speech recognition apparatus 100 has a recognition result “lighting”, the result is forwarded as SIG3 to the output unit 110. The output unit 110 outputs an output SIG4 corresponding to the remote-control signal. This holds the information about a relationship between a recognition result by the speech recognition apparatus 100 and the electronic appliance group 125 to be actually controlled. For example, in either case the output from the SIG3 is “lighting” or “lamp”, conversion is made as a signal to a lighting appliance 126 of the electronic appliance group 125 whereby the information about the lighting appliance 126 is forwarded as SIG4 onto the remote-control signal generator unit 124.

The remote control signal generator unit 124 converts the content information received as SIG4 representing control signal of a to-be-controlled appliance into an infrared-ray remote-control signal, and then outputs it as SIG5 to the electronic appliance group 125. The remote control signal generator unit 124 is configured to issue an infrared-ray remote-control signal over a broad range, to issue a signal simultaneously to all the appliances capable of receiving an indoor infrared-ray remote-control signal. Because an on/off toggle signal is sent by the SIG5 to the lighting appliance 126, putting on/off the lighting appliance can be carried out in a manner according to a user's speech. In the case that the electronic appliance group 125 placed under control of turning on/off power is a video recorder 127, the word “video” spoken by the user is recognized. In the case of the television 128, the word “television” is recognized to effect similar control.

It is assumed that the integrated speech remote-control unit for home-use appliances of the Embodiment 4 is installed within a household in a set state in which nearly 100 words are recognizable, wherein the household comprises only adult men and women. Even if the user sets the switch 122 not to make speaker normalization by the switch 122, the probability to put on/off lighting according to an utterance “lighting” can be 98% or higher provided that the speaker is an adult man or woman, as shown in FIG. 11C. However, in the case the speaker is a child, recognition is as low as nearly 84% without speaker normalization. It is generally considered that, where recognition performance can be secured 90% or higher, the user would consider “the apparatus operates accurately to utterance”. However, in the case of 84%, it would be considered as an “apparatus not perfectly but substantially operable to utterance”. On the other hand, even in case speaker normalization is carried out as indicated by the switch 122, recognition rate is obtainable 93% even if the speaker is a child. Thus, “the apparatus is operable to utterance” for the child.

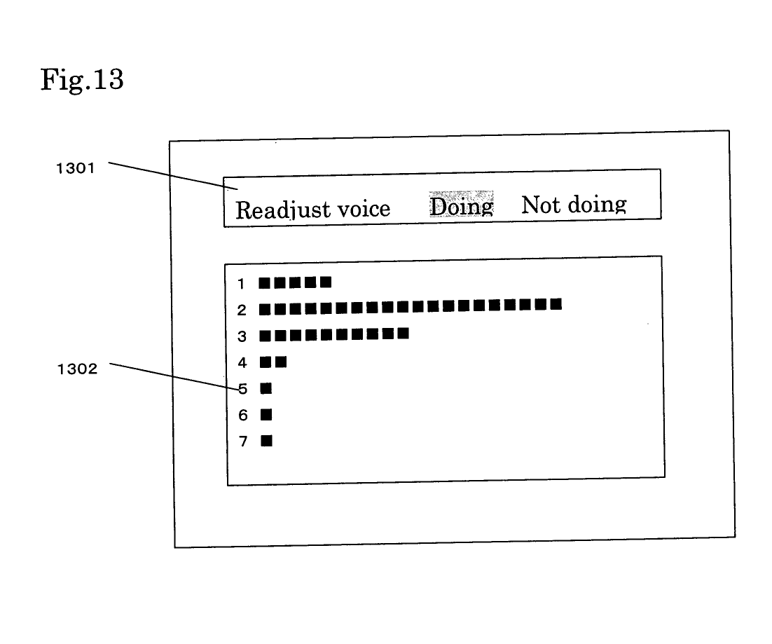

Speaker normalization, in situation, is displayed on the display unit 123 and hence quite obvious for the user. In order to make sure the speaker normalization process clearly, the display device 123 may make a display of character display 1301, e.g. “Readjust Voice Now In Process Not In Process” representative of making speaker normalization, as shown in FIG. 13. When speaker normalization is being carried out, “Now In Process” may be displayed with emphasis. When speaker normalization is not being carried out, “Not In Process” may be displayed with emphasis. In FIG. 13, because speaker normalization is under processing, the area “Now In Process” is changed in display color for emphasis.

Meanwhile, the parameter weights on seven discrete values α₁ to α₇ for frequency conversion determined in the speech recognition apparatus 100, if displayed on a weight display graph 1302, provides more explicit display.

Although the present embodiment 4 showed the case that speaker normalization is used on the integrated speech remote-control unit for home-use appliances, the present embodiment 4 operable for a user side only by making a selection as to whether or not to make a speaker normalization and giving an instruction to start a speech recognition is similarly applicable, particularly, for such an appliance in which the user may change without notice, such as street guide terminal unit capable of speech operation, and appliance of coin telephone capable of speech operation.

Incidentally, where speaker normalization is made at all times, the switch 122 may be removed in the configuration. In this case, the user can use in a simple way because of making only instructing to start speech recognition.

The speaker normalization method and speech recognition apparatus using the same of the invention is useful for speech control unit, such as integrated speech remote-control unit for home use appliances, street guide terminal unit capable of speech operation, and appliance of coin telephone capable of speech operation where there is exchange of user without notice.

What is claimed is:

1. A method or speaker normalization comprising:
a feature parameter extracting step of segmenting an input speech utterance into a constant time length to have frames and extracting acoustic feature parameter of each of the frames;
a frequency converting step of frequency-converting the acoustic feature parameter by using plural frequency conversion coefficients previously defined;
a step of using all the combinations of plural post-conversion feature parameters obtained by the frequency conversion and at least one standard phonemic model, to compute plural similarities or distances between the post-conversion feature parameters of each of the frames and the standard phonemic model;
a step of deciding a frequency converting condition for normalizing the input utterance by using the plural similarities or distances; and
a step of normalizing the input utterance by using the frequency converting condition.

2. A method according to claim 1, wherein the step of deciding a frequency converting condition has a step of mutually comparing between the plural similarities or distances included in an input frame constituted by the frame, a step of selecting for each frame a maximum likelihood, combination of a phoneme and a frequency conversion coefficient by using a result of comparison, and a step of cumulating the frequency of the frequency conversion coefficient in a maximum likelihood over plural frames and deciding a frequency conversion coefficients in highest frequency as a frequency converting condition.

3. A method according to claim 1, wherein the step of deciding a frequency converting condition has a step of mutually comparing between the plural similarities or distances included in an input frame constituted by the frame, a step of selecting a set of a phoneme of the standard phonemic model and a frequency conversion coefficient that provides a result of maximum likelihood, and a step of deciding the selected frequency conversion coefficient as a frequency converting condition of the frame.

4. A method according to claim 1, wherein the step of computing a similarity or distance further includes a step of computing, for each frame, a ratio in similarity or distance of the phoneme as a weight by using the frame-based acoustic feature parameter of the frame and the standard phonemic model, the step of deciding a frequency converting condition being a step to decide the frequency converting condition by using the weight.

5. A method according to claim 4, wherein the step of computing the similarity or distance of the phoneme as a weight includes a step of selecting for each frame a frequency conversion coefficient in a maximum likelihood with respect to all the phonemes of the standard phonemic model, a step of deciding a phoneme based frequency converting condition for all the phonemes, on all the phonemes of the standard phonemic model, from a result of cumulating phoneme by phoneme the frequency converting condition in a maximum likelihood over a plural frames, and a step of using the phoneme-based frequency converting condition and the similarity or distance, to decide for each frame a weight for the phoneme-based frequency converting condition, wherein the step of deciding a frequency converting condition decides a frequency converting condition for the frame by using the weight on the phoneme-based frequency converting condition.

6. A method according to claim 1, wherein, said step of deciding frequency converting condition employs at least vowels in comparing similarities or distances.

7. A method according to claim 1, wherein, said step of deciding frequency converting condition employs only vowels in comparing similarities or distances.

8. An apparatus for speech recognition comprising:
a feature parameter extracting section for segmenting an input speech utterance into a constant time length to have frames and extracting acoustic feature parameter of each frames;
a frequency converting section for frequency-converting the acoustic feature parameter by using plural frequency conversion coefficients previously defined;
a similarity or distance computing section for using all combinations of plural post-conversion feature parameters obtained by the frequency conversion and at least one standard phonemic model, to compute plural similarities or distances between the post-conversion feature parameter of each frames and the standard phonemic model;
a frequency converting condition deciding section for deciding a frequency converting condition for normalizing the input utterance by using the plural similarities or distances; and
a speech-recognition processing section for recognizing a speech by using the input utterance and a subject-of-recognition acoustic model;
whereby the input utterance is normalized by using the determined frequency converting condition thereby effecting speech recognition.

9. An apparatus according to claim 8, wherein the frequency converting condition deciding section mutually compares between the plural similarities or distances included in an input frame constituted by the frame, selects for each frame a maximum likelihood of combination of a phoneme and a frequency conversion coefficient by using a result of comparison, and cumulates the frequency of the frequency conversion coefficients in the maximum likelihood over the plural frames and decides a frequency conversion coefficient highest in frequency as a frequency converting condition.

10. An apparatus according to claim 8, wherein the frequency converting condition deciding section mutually compares between the plurality of similarity degrees or distances included in an input frame constituted by the input frame, selects a combination of a phoneme of the standard phonemic model and a frequency conversion coefficient that provides a result of maximum likelihood, and decides the selected frequency conversion coefficient as a frequency converting condition of the frame.

11. An apparatus according to claim 8, wherein the similarity or distance computing section computes, for each frame, a ratio in similarity or distance of the phoneme as a weight by using the frame-based acoustic feature parameter and the standard phonemic model, the frequency converting condition deciding section deciding the frequency converting condition by using the weight.

12. An apparatus according to claim 11, wherein the similarity or distance computing section selects for each frame a frequency conversion coefficient in a maximum likelihood with respect to all the phonemes of the standard phonemic model, decides a phoneme-based frequency converting condition for all the phonemes, on all the phonemes of the standard phonemic model from a result of cumulating phoneme by phoneme the frequency converting condition in a maximum likelihood over plural frames, and uses the phoneme-based frequency converting condition and the similarity degree or distance, to decide a weight for the phoneme-based frequency converting condition for each frame, wherein the frequency converting condition deciding section decides a frequency converting condition for the frame by reflecting the weight on the phoneme-based frequency converting condition.

13. An apparatus according to claim 8, wherein said frequency converting condition deciding section employs at least vowels in comparing similarities or distances.

14. An apparatus according to claim 8, wherein said frequency converting condition deciding section employs only vowels in comparing similarities or distances.

15. An apparatus according to claim 8, comprising a frequency converting condition process display section for displaying, for a user, intermediate data obtained by an internal process of the frequency converting condition deciding section.
